(19) United States
(12) Patent Application Publication
(10) Pub. No.: US 2010/0037876 A1
(43) Pub. Date: Feb. 18, 2010

(54) Two-stroke internal combustion engine with valves for improved fuel efficiency

(76) Inventor: Barnett Joel Robinson, Newton, MA (US)

Correspondence Address: David M. Warren, 655 Oakland Ave., Cedarhurst, NY, 11516, US

(21) Appl. No.: 12/228,791

(22) Filed: Aug. 15, 2008

(51) Int. Cl. F02B 25/18

(52) U.S. Cl. 123/65 PE

(57) ABSTRACT

A two-stroke cycle internal combustion engine has a cylinder with a cylinder head closing off an end of the cylinder, a crankshaft and a piston connecting with the crankshaft to move the piston in a reciprocating movement within the cylinder. Intake and exhaust valves move into and out of a combustion chamber for openings and closures of the valves. A mixture of fuel and air is forced into the cylinder during an open interval of the intake valve beginning in the middle of the upstroke and terminating in a range of 20-60 degrees before top dead center to improve efficiency and choice of fuel by minimizing compressive forces of the piston during the upstroke. Timing of the closure of the intake valve may be delayed automatically with a reduction in crankshaft angular speed.

### FIELD OF THE INVENTION

This invention relates to a two-stroke internal combustion engine with an oil pump and crankcase, and intake and exhaust valves and force-fed intake fuel-air mixture for improved fuel efficiency.

### BACKGROUND OF THE INVENTION

Internal combustion engines have been constructed in the forms of two-stroke and four-stroke engines. In both forms of the engine, the engine employs one or more cylinders, each cylinder having a piston movable therein with reciprocating motion for the driving of a crankshaft of the engine. Output power of the engine, for the driving of a load, is obtained from the rotating crankshaft. A cylinder head closes off one end of each of the cylinders, opposite the crankshaft. In each of the pistons, the piston connects via a connecting rod to an arm of the crankshaft for conversion between the reciprocating motion of the piston and the rotational motion of the crankshaft. A combustion chamber is defined within each cylinder in the space between the top surface of the piston and the cylinder head. The piston is said to undergo a downstroke upon movement of the piston away from the cylinder head (thereby increasing the volume of the combustion chamber), and to undergo an upstroke upon movement of the piston toward the cylinder head (thereby decreasing the volume of the combustion chamber).

In the four-stroke engine, two complete cycles of revolution of the crankshaft with four strokes of the piston are required to draw in a mixture of fuel and air into the combustion chamber (induction stroke), to compress the fuel-air mixture (compression stroke), to allow for expansion of the burning gasses after ignition for powering rotation of the crankshaft (power or expansion stroke), and for exhausting the gaseous products of combustion from the combustion chamber (exhaust stroke). In the usual form of the four-stroke engine, an intake valve and an exhaust valve, which are located in the cylinder head or in the engine block for each cylinder, operate in synchronism with the rotational movement of the crankshaft via a camshaft rotating at half the rotational speed of the crankshaft.

In the two-stroke engine, the foregoing functions are accomplished within one complete cycle of revolution of the crankshaft with two strokes (one downstroke followed by one upstroke) of the piston. In a common form of construction of the two-stoke engine in the prior art, both an exhaust port and an intake port are placed in a sidewall of the cylinder at approximately central locations between the top dead center position and the bottom dead center position of the top surface of the cylinder head. During an initial portion of the downstroke, following ignition of the fuel-air mixture, there is expansion of the burning gasses. This is followed, beginning at approximately the middle of the downstroke by an exhausting of the combustion products via the exhaust port in the sidewall of the cylinder.

The locating of the exhaust port in the sidewall of the cylinder provides for mechanical simplicity in the construction of the engine, whereby the piston head moving past the exhaust port acts as a valve element to open and to close the exhaust port. In similar fashion, the locating of the intake port in the cylinder sidewall, preferably slightly below the location of the exhaust port, provides for mechanical simplicity such that, immediately after the opening of the exhaust port, the moving piston head opens the intake port for drawing the fuel-air mixture into the cylinder. As the exhaust gasses blow out the exhaust port, in conjunction with further downward movement of the piston, the intake fuel-air mixture flows into the cylinder. During the subsequent movement of the piston, the piston reverses direction and enters the upstroke and, at approximately the midpoint of the upstroke, closes the intake port and the exhaust port, thus terminating both the induction phase and the exhaust phase of the engine operation. During the remainder of the upstroke, the piston compresses the air-fuel mixture. The spark plug fires shortly before the piston reaches top-dead center.

The four-stroke engine operates in accordance with the Otto cycle, and may be referred to herein as a gasoline engine, as distinguished from a diesel engine. In the usual construction of a multiple-cylinder four-stroke gasoline engine, an intake manifold is provided for bringing air and fuel from a carburetor or fuel-injection assembly to the intake valves of the cylinders, and an exhaust manifold is provided for removal of combustion gases via exhaust valves of the cylinders. The arrangement of intake and exhaust manifolds is also provided for a multiple-cylinder two-stroke gasoline engine.

It is useful to compare operation of the gasoline engine with the diesel engine. In the case of the gasoline engine, both fuel and air are present in the cylinder during the compression stroke. The temperature produced in the gases within the cylinder is below the ignition temperature of the air-fuel mixture so as to avoid premature ignition of the air-fuel mixture. Ignition is initiated by an electric spark of a spark plug, mounted within the cylinder head. In a modern engine, activation of the spark plug at an optimum moment, relative to the time of occurrence of the power stroke, is provided by a computer. In the case of the diesel engine, only the air is present in the cylinder during the compression stroke. The geometry of the piston within the cylinder of the diesel engine differs somewhat from the corresponding geometry of the gasoline engine such that the compression stroke of the diesel engine provides significantly more compression of the gases (which is only air in the diesel engine for a compression ratio of approximately 15:1) within the cylinder than occurs in the gasoline engine (with compression of an air-fuel mixture for a compression ratio of approximately 8:1). As a result, in the diesel engine, the temperature of the air is raised by the compression stroke to a temperature high enough to ignite fuel. Accordingly, in the diesel engine, the fuel is injected into the cylinder at approximately the beginning of the power stroke, and is ignited by the high air temperature. The diesel engine has been employed both in the four-stroke and the two-stroke forms of engine.

It is observed furthermore, that in the usual construction of a four-stroke gasoline engine and of a four-stroke diesel engine, the ratio of the expansion of the volume of cylinder gases, final volume divided by initial volume of the power stroke, is equal to the inverse of the ratio of the compression of the volume of the cylinder gases, initial volume divided by final volume of the compression stroke. By way of example for a gasoline engine, compression and expansion is characterized by a ratio of approximately 8:1, and for a diesel engine, compression and expansion is characterized by a ratio of approximately 15:1. The expansion of the cylinder gases in the power stroke is accompanied by a reduction in the temperature of the cylinder gases. Well-known theoretical considerations show that an important consideration in determining the efficiency of the engine is the ratio of the gas temperature at the beginning of the power stroke to the gas temperature at the end of the power stroke. A greater temperature ratio is obtained in the case of the diesel engine than for the gasoline engine. This is one of the reasons that the diesel engine can operate more efficiently than the gasoline engine.

Another way of looking at the reason that the diesel engine can operate more efficiently than the gasoline engine is that the diesel combustion chamber is half the size of the comparable gasoline engine combustion chamber. It is known from thermodynamics that PV=NRT. (Pressure×Volume=Quantity of Fuel×Fixed Factor×Temperature.) Since the diesel combustion chamber is smaller, it requires less fuel to reach the same pressure and temperature as the gasoline engine. But it does not reach it's full potential because it has to overcome the greater compression ratio.

Based on the foregoing theoretical consideration, it appears that there would be an advantage to the construction of a gasoline engine with a higher, or elevated, expansion ratio of the power stroke without a corresponding increase in the compression ratio of the compression stroke and, if possible, a compression ratio lower than that usually found in the gasoline engine. By maintaining the relatively low value of the compression ratio in the compression stroke, the temperature of the cylinder gases would be maintained at a sufficiently low value so as to avoid premature ignition, as in present-day gasoline engines, while greater efficiency would be obtained as in present-day diesel engines. A further advantage of such an engine would be the avoidance of needless excess compression during the compression stroke, a matter which can be appreciated by one attempting to start an engine by hand.

Such a construction of an elevated expansion-ratio engine would be advantageous for the form of the internal combustion engine, generally used for powering automobiles, that operates in accordance with the Otto cycle, as well as other “mixed” cycle four stroke-repeating internal combustion engines. Such a construction of an elevated expansion-ratio engine would be advantageous also for a diesel engine wherein an expansion ratio in the power stroke of 20:1, by way of example, could be obtained for still greater efficiency while the compression ratio of the compression stroke would be maintained at 15:1.

There is a practice in the construction of the four-stroke gasoline engine (as used in automobiles) of keeping the intake valve open, during the induction stroke, past bottom dead center, this resulting in a small decrease in the compression of the compression stroke. Robinson (the inventor herein) in his U.S. Pat. No. 6,907,859 discloses a four-stroke internal combustion engine providing an expansion ratio that is elevated relative to the compression ratio without keeping the intake valve open past bottom dead center. This patent teaches removal of half of the charge of the cylinder during the compression stroke for reducing the compression ratio, and employing a smaller combustion chamber at top dead center for an increased expansion ratio. Further embodiments are disclosed in Robinson U.S. Pat. No. 7,322,321 and in pending application Ser. No. 11/810,908 (Publication No. 20080035105). It has also been found that the efficiency is dependent on the interval of time, within the exhaust stroke, during which the exhaust valve is open and, more specifically, that an advancement of the time of the opening of the exhaust stroke in a four-stroke engine improves efficiency as is taught in Robinson U.S. Pat. No. 7,040,264.

The greater efficiency makes more power available at the wheels of a vehicle, driven by the engine, per gallon of fuel consumed by the vehicle. It is the power available at the wheels that serves to move the vehicle. In an efficient engine, more energy in the gallon of fuel is available to push the vehicle and less of the fuel is required to operate the engine. By way of example, even in an idling engine, there is significant wasting of energy. It is believed that engine tasks, such as the compressing of a fuel-air mixture in the compression stroke, and the sucking in of fuel-air mixture during the induction stroke require energy from the fuel, and are a source of wastage of fuel if these tasks consume more energy than is necessary for the driving of the vehicle. The engine configurations disclosed in the aforementioned Robinson patents are believed to attain the improved efficiencies, at least in part, from a reduction in the amount or work that must be done by the engine in the power and the compression strokes. The energy wasted in the power stroke is the work required to slow down the piston when the combustion gases are not allowed to leave the combustion chamber at 90 degrees before bottom dead center as taught in Robinson's U.S. Pat. No. 7,040,264.

It is believed that such improvements in efficiency can be even more effective in a two-stroke engine because they reduce even further the work required to operate the engine itself. Two-stroke engines are known to require less fuel in their operation because each power stroke in a two stroke engine has to rotate the crankshaft journal of its respective piston only one revolution (360 degrees) and not the two revolutions (720 degrees) required by the power stroke of a four-stroke engine. It is noted also that the simplified mechanical design, generally employed in the two-stroke engine, while introducing reliability due to the mechanical simplicity of the engine, suffers from the disadvantage of noxious engine emissions associated with the addition of engine lubricant to the fuel. It is necessary to add engine lubricant to the gasoline because the intake and exhaust ports in the cylinder walls do not allow for the use of a lubricating-oil crankcase and its associated oil pump to keep the engine components lubricated properly. In a 2 stroke diesel engine, the lubricity is in the fuel itself.

Further observations in the operation of the two-stroke engine of the prior art are of interest. In the gasoline two-stroke engine, the exhaust port is located, typically, in the cylinder sidewall at approximately 90 degrees after top dead center. The intake port is a little closer to top dead center so that, on the upstroke, the piston will significantly close the exhaust port before closing the intake port. The continued upward motion of the piston produces a compression of the intake air fuel mixture in an amount of approximately 5:1. For an octane fuel, the resulting temperature rise, from the compression, is not enough to produce ignition or the air-fuel mixture. However, in experiments by the present inventor, it has been observed that an intake fuel-air mixture employing heating oil or diesel fuel is subject to ignition before the piston reaches top dead center.

In the diesel two-stroke engine, the intake is accomplished by use of a port in the sidewall of the cylinder, which port is positioned at the bottom of the piston stroke, so as to be available to provide ingress of air (this is air only, because the fuel for the diesel is injected into the combustion chamber with the piston in the vicinity of top dead center) after which the piston travels upward to close off the intake port and then to compress the air (approximately 15:1) making the air hot enough to ignite the fuel as it is injected into the combustion chamber. A normal moving valve is employed for the exhaust, wherein the exhausting of the combustion products is completed before inception of the ingress of the intake air.

### SUMMARY OF THE INVENTION

The invention provides for improvement in efficiency and reduction in noxious exhaust fumes for a two-stroke engine. The improvement in efficiency is obtained by a further reduction in compression of the engine gasses (the fuel-air mixture) during the piston upstroke, while providing a desired ratio of expansion of the engine gasses (products of combustion of the fuel in air) during the following piston downstroke. The improvement of reduced emission of the noxious exhaust fumes is accomplished by the following features of construction: (1) each cylinder of the engine is constructed without sidewall ports for exhaust of combusted gasses and for intake of fuel-air mixture, which sidewall ports were (in the prior art) located at positions wherein the ports were blocked by the piston head during parts of the piston strokes; (2) exhaust and intake valves are located in a cylinder head or in the engine block, and open into the combustion chamber of the cylinder above the location of the piston at top dead center; and (3) lubricant (typically engine oil) is held, below the crankshaft, within a crankcase of the engine and is fed, under pressure of an oil pump, from the crankcase and directed to various locations within the engine, such as the mechanisms which open and close the valves.

With respect to further detail in the construction of the two-stroke engine, the engine has one or more cylinders, with each cylinder having a piston movable therein with reciprocating motion for the driving of a crankshaft of the engine. The preferred embodiment of the invention will be described below for a two-stroke, four-cylinder in-line engine, wherein an intake air-fuel mixture is provided to the respective cylinders by an intake manifold and wherein an exhausting of products of combustion is provided for the respective cylinders by an exhaust manifold. Output power of the engine, for the driving of a load, is obtained from the rotating crankshaft. A cylinder head closes off one end of each of the cylinders, opposite the crankshaft. For each of the cylinders, the exhaust valve and the intake valve, which are located in the cylinder head or engine block, serve for exhausting products of combustion from the combustion chamber and for introduction of a fuel-air mixture into the combustion chamber.

It is noted that, while the description of the engine is provided in terms of a cylinder having an intake valve and an exhaust valve, it is common practice to use more than one intake valve and more than one exhaust valve in a single cylinder. However, to facilitate an understanding of the invention, reference is made to simply a single intake valve and a single exhaust valve, it being understood that the description applies also to the case of an engine cylinder operating with plural intake valves and/or plural exhaust valves.

In the preferred embodiment of the invention, the valves are driven by a camshaft assembly wherein, for each cylinder, a single camshaft drives both of the exhaust and the intake valves or, alternatively, separate camshafts are provided for each of the exhaust and the intake valves. The valves, in cooperation with the camshaft assembly, constitute a valve assembly operable with a computer, which is responsive to engine and vehicular driving parameters, to enable operation of the engine in an automatic mode wherein the closing times of an intake valve are selectable automatically in response to vehicular driving conditions. Since, in a two stroke engine the camshaft rotates at the same speed as the crankshaft, the cams can be part of the crankshaft, if desired, eliminating the need for a separate camshaft. The crankcase, which serves for holding the lubricating oil, encircles the crankcase and is attached to the engine block opposite the cylinder head.

A complete cycle in the operation of a cylinder occurs within a single revolution of the crankshaft, and includes: (1) ignition of the fuel-air mixture at a terminal stage of the upstroke, (2) the burning of fuel for driving the piston in the initial stage of the downstroke, (3) the exhausting of the products of combustion during the final stage of the downstroke and may continue into the initial stage of the upstroke, and (4) the introduction of the fuel-air mixture with a following relatively small amount of compression of the fuel-air mixture at a middle stage following the closing of the exhaust valve and prior to the terminal stage of the upstroke. It is noted that, at the terminal phase of the upstroke, the piston is located very close to the cylinder head, and continued rotation of the crankshaft produces relatively little movement of the piston. Therefore, the conclusion of the induction of fuel (which, in the preferred embodiment is a vaporous mixture of fuel and air) concurrently with the location of the piston being very close to the cylinder head insures a minimization of any compression of the fuel-air mixture prior to ignition of the fuel.

The timing of the operations of the intake valve and the exhaust valve provides for the following timing program wherein a camshaft makes one complete revolution for each revolution of the crankshaft. (This is in contradistinction to the operation of a four-stroke engine wherein a camshaft makes one revolution for two revolutions of the crankshaft.) The engine timing provides for an opening of the exhaust valve, beginning to open at approximately 90 degrees before bottom dead center, and for closing when the vast majority of the exhaust gases have left the combustion chamber. This could be anywhere from 45 degrees before bottom dead center until approximately 80 degrees after bottom dead center. The intake valve begins to open at or after the crankshaft position at which the exhaust valve has closed but sufficiently early so that enough of the air fuel mixture enters the combustion chamber to satisfy the needs of the engine's demands. Subsequently, the intake valve closes to be fully closed at approximately 30 degrees before top dead center, and the spark plug ignites shortly thereafter at approximately 20 degrees before top dead center.

A turbocharger or a blower (such as a supercharger) pushes the air-fuel mixture into the combustion chamber via the intake manifold and intake valve. The blower is powered either by electricity or can be belt driven by the crankshaft or camshaft, or be directly driven by either of these two shafts. The throttling of the intake air and the metering of the fuel (such as gasoline) is computer controlled in accordance with current practice in the automobile industry. Therefore, the air-fuel mixture is “pushed” into the combustion chamber rather than being drawn in by vacuum. Pushing of intake air towards the combustion chamber entails less work by the engine than the drawing of air into the combustion chamber by a vacuum. In the construction of the two-stroke engine in the in-line configuration with four cylinders, the first and the fourth cylinders fire simultaneously. The second and third cylinders also fire simultaneously and do so 180 crankshaft degrees after cylinders 1 and 4 have fired.

### BRIEF DESCRIPTION OF THE DRAWING

The aforementioned aspects and other features of the invention are explained in the following description, taken in connection with the accompanying drawing figures wherein:

FIG. 1 shows diagrammatically a view of an internal combustion engine operative with a two-stroke cycle and employing separate camshafts for intake and exhaust valves in accordance with one embodiment of the invention;

FIG. 2 is a stylized view of piston movement in the engine of FIG. 1, the view including an oil pump for lubricating the engine;

FIG. 3 shows diagrammatically successive locations of an arm of a crankshaft during reciprocating motion of the piston of FIG. 2, useful in explaining operation of the present invention;

FIG. 4 is a timing diagram showing operation of the engine of FIG. 1;

FIG. 5 shows a form of construction of the engine of FIG. 1 wherein four cylinders are arranged in line with all valves sharing a common camshaft for a driving of the valves; and

FIG. 6 shows construction of a further embodiment of a valve assembly for the engine of FIG. 1 wherein, in a valve assembly, valve stems run parallel to an axis of a cylinder to enable placement of valve-driving cams directly on the crankshaft to avoid use of a separate camshaft.

Identically labeled elements appearing in different ones of the figures refer to the same element but may not be referenced in the description for all figures.

### DETAILED DESCRIPTION OF THE INVENTION

With respect to both four-stroke and two-stroke engines, it is useful for appreciating the present invention in the two-stroke engine to review the effect of constructing pistons of different length, so as to understand the effect of using a taller piston in providing a higher expansion ratio in a given cylinder than is obtained with the use of a shorter piston. By way of example in the construction of a piston within its cylinder, in the case of a gasoline engine operating with the four-stroke process, when the piston in the cylinder is at top dead center (TDC), there is 1 cm (centimeter) between the top surface of the piston and the cylinder head. If the length of a stroke is 7 cm, then at bottom dead center (BDC) there is 8 cm from the top of the piston head to the cylinder head, this resulting in a compression stroke with 8:1 compression ratio and a power stroke expansion ratio of 8:1. The diesel engine four-stroke cycle differs from this pattern only by having a higher compression ratio and a correspondingly higher expansion ratio.

In the foregoing example, for the diesel engine one may consider making the piston to be 0.5 cm taller than the original piston. This changes the geometric ratio from the previous value (8 cm to 1 cm), with corresponding compression and expansion ratios of 8:1 obtained with the original piston, to a geometric ratio of 7.5 cm (the distance from bottom dead center to the cylinder head) to 0.5 cm (the distance from top dead center to the cylinder head) with a corresponding expansion ratio of 15:1 in the power stroke. In the case of an engine having the feature of the elevated expansion ratio of the Robinson patents, that feature can prevent the compression ratio of the compression stroke from rising above 8:1 by use of the return valve with holding tank and discharge valve for releasing some of the gases (or vapor) in the cylinder during the beginning of the compression stroke. The result is that the compression stroke retains its compression ratio of approximately 8:1 (assuming that the return valve closes when the piston position is half way through the compression stroke) while the expansion stroke has the aforementioned expansion ratio of 15:1. By this usage of different ratios in the compression and the expansion strokes, the engine with the elevated expansion ratio may be said to change an engine's operational aspect ratio of expansion ratio to compression ratio from today's regular industrial standard of 1:1 to an elevated level of about 2:1, or even 3:1, in gasoline engines.

It is noted that in the case of the two-stroke gasoline engine, there is no full-length compression stroke, and only a portion of the upstroke subsequent to injection of a fuel-air mixture (in the prior art) provides effectively a reduced-length of compression stroke. However, the two-stroke engine of the present invention provides still further reduction in the amount of compression of the fuel-air mixture by using the form of valves normally employed in a four-stroke engine, specifically the exhaust valve and the intake valve associated with an engine cylinder, to provide for the exhaust interval and the intake interval. This enables optimum times for initiation and termination of the exhaust interval and of the intake interval.

With respect to the sole cylinder of a two-stroke engine having a single cylinder, and with respect to each of the cylinders of a two-stoke engine having multiple cylinders, the following operation takes place, in accordance with the invention. In the case of the exhaust interval, the use of the exhaust valve enables the two-stoke engine to maintain a state of the engine exhaust mode which is completed when most of the exhaust gases have left the combustion chamber.

In the case of the preferred embodiment of the invention, an inline four-cylinder two-stroke engine, the exhaust valve opens at 80 degrees BBDC (before bottom dead center) and closes 80 degrees ABDC (after bottom dead center). Thereafter, as the piston progresses upwards during the upstroke, there is opportunity to open the intake valve to initiate the air-fuel induction mode. The air-fuel induction mode begins with the beginning of the opening of the intake valve and takes place at any time after the exhaust valve closes but not later than approximately 90 degrees before top dead center. Accordingly, the latest closure of the exhaust valve would be at approximately 80 degrees after bottom dead center. The air-fuel induction mode may terminate as early as 50-60 degrees before top dead center, but no later than the arrival of the piston in the region of travel adjacent to the head (approximately 30 degrees before top dead center, BTDC). Preferably, the closure of the intake valve should occur in the region of 30-50 degrees before top dead center. The intake valve is to be fully closed by 30 degrees BTDC. This is followed by ignition of the fuel, of the fuel-air mixture, at approximately 20 degrees before top dead center. Ignition is accomplished by use of a spark plug.

The ignition occurs in a region of proximity of the piston to the cylinder head, wherein continued rotation of the crankshaft produces relatively little movement of the piston, relative to the cylinder head, with a consequent minimization of compression of the intake fuel-air mixture. It is anticipated that the intake air-fuel mixture will be under a pressure of a fraction of an atmosphere above ambient pressure. With respect to closure of the intake in the range of 50-30 degrees BTDC, it is believed that the rising piston will produce a compression in the range of 1.5:1 to 3:1, which compression is not enough to raise the temperature of the fuel-air mixture enough to ignite the fuel, whether the fuel is an octane fuel or diesel fuel. Ignition is produced only by the spark plug.

Therefore, the wastage of energy associated with a compression stroke does not occur in the two-stroke engine of the invention, and the saved energy becomes available for the driving of a vehicle. Furthermore, in the practice of the invention, one is free to select a tall piston (or an equivalent way to decrease the size of the combustion chamber) for a high expansion ratio and the resultant higher efficiency in the operation of the engine. As a result, the practice of the invention provides the benefit of a significant savings in fuel consumed by the engine.

A further benefit of the invention is a capability of combusting diesel fuel (home heating oil, kerosene) by means of the spark plug, this without any danger of a preignition. These fuels are readily atomized, suspended in air and vaporized by use of a fuel injector that injects the fuel into the intake air of the intake manifold. Alternatively, a gaseous fuel such as butane, ethane, etc. can also be mixed into the intake air. The fuel burns cleanly because there is no mixing of lubricating oil with the fuel. Independently of which fuel is used, the invention provides for the standard reservoir of lubricating oil with the oil pump for distributing the oil throughout the engine, in which case the fuel burns cleanly because there is no mixing of lubricating oil with the fuel.

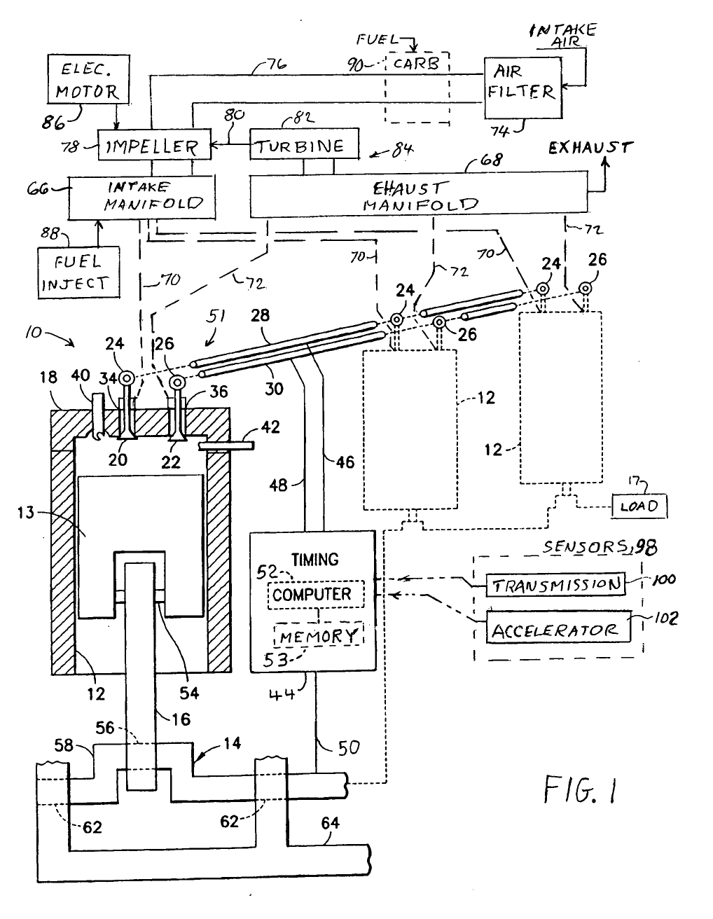

FIG. 1 shows a diagrammatic view of a two-stroke engine 10 having a plurality of cylinders 12 with pistons 13 therein. The invention can be practiced with an engine having only one cylinder or with an engine having multiple cylinders, wherein a preferred embodiment of the invention is practiced with an engine having an inline arrangement of four cylinders. In the example of FIG. 1, one of the cylinders 12 is sectioned to show its piston 13, and the remaining cylinders 12 are shown in phantom view. With respect to an individual one of the cylinders 12, the piston 13 connects with a crankshaft 14 of the engine 10 by a connecting rod 16, and translates within the cylinder 12 with reciprocating motion during rotation of the crankshaft 14. The crankshaft, in turn, imparts rotation to a load 17 such as the transmission of a vehicle to be driven by the engine 10.

Motion of the piston 13 is characterized by a repeating sequence of two strokes, namely, a downstroke followed by an upstroke, the two-stroke sequence being completed once for each rotation of the crankshaft 14. During the downstroke, the distance between the piston 13 and a head 18 of the cylinder 12 increases to provide for an increase in the volume of the cylinder available for containing gases within the cylinder. During the upstroke, the distance between the piston 13 and the head 18 decreases to provide for a decrease in the volume of the cylinder available for the containment of gases within the cylinder. Typically, in the construction of the cylinder head 18, the interior of the head 18 may be provided with a complex shape to enhance combustion within the cylinder 12; however, for an understanding of the present invention, the interior of the cylinder head 18 may be represented by the more simple shape of a right circular cylinder as shown in FIG. 1.

The engine 10 further comprises an intake valve 20, and an exhaust valve 22 located in the cylinder head 18. The valves 20 and 22 are operated, respectively, by cams 24 and 26 of camshafts 28 and 30. It is understood that the two camshafts are provided by way of example, and that, by way of further example, a single camshaft with two cams thereon may be employed for operation of the foregoing valves. The intake valve 20 is operative to close and to open an intake port 34 of the head 18. The exhaust valve 22 is operative to close and to open an exhaust port 36 of the head 18. Thus, the two valves 20 and 22 may be constructed in the same fashion as the intake and exhaust valves of a four-stroke engine, but the cyclic operation of the two valves in the two-stroke engine differs from that of the four-stroke engine in that the cyclic operation of these two valves in the two-stroke engine provides for one complete cycle of the valve operation for each cycle of crankshaft rotation. (By way of comparison, in the four-stroke engine, one complete cycle of four strokes takes place during two cycles of the crankshaft rotation.)

Also shown in FIG. 1 is a spark plug 40 for ignition of gases in the cylinder 12 for operation of the engine with gasoline as well as with kerosene. By way of alternative embodiment of the invention, it is noted that the engine 10 can be operated as a two-stroke diesel engine wherein a compression phase of the upstroke on intake air provides for a compression ratio of much lower value than the value of the expansion ratio in the succeeding downstroke, for which case of alternative form of construction, FIG. 1 also shows a fuel injector 42 for injecting fuel into the heated air of the cylinder 12 immediately before commencement of a downstroke.

The engine 10 also includes a timing device 44 for synchronizing rotation of the crankshaft 14 with rotations of the camshafts 28 and 30. Lines 46 and 48 represent, respectively, connections of the timing device 44 to the camshafts 28 and 30. Line 50 represents connection of the timing device 44 to the crankshaft 14. In the practice of the invention, the driving of the valve 20 and the valve 22 may be accomplished by well-known mechanical, hydraulic or electromagnetic apparatus synchronized to the crankshaft 14, which apparatus is represented diagrammatically by the camshafts 28 and 30 and the timing device 44. The valves 20 and 22 with their respective camshafts 28 and 30 constitute a valve assembly 51 whereby the openings and the closings of the valves are controlled. By way of example, in the case of a mechanical driving of the valves 20 and 22, the timing device 44 with its connecting lines 46, 48 and 50 may be provided by means of gearing and a timing belt (not shown) which interconnects gears on the crankshaft 14 and on the camshafts 28 and 30 to provide equal rates of rotation of the rotations of the camshafts 28 and 30 relative to the rotation of the crankshaft 14, and wherein the timing of the rotations of the camshafts 28 and 30 can be adjusted relative to each other and to the crankshaft as in variable valve timing under computer control currently available in a modern computer controlled automotive engine.

By way of further example, in the case of an electromagnetic driving of the valves 20 and 22, the timing device 44 may be provided with a computer 52, the line 50 represents a shaft angle encoder providing instantaneous values of the angle of the crankshaft 14 to the computer 52, and the lines 46 and 48 represent electric motors for rotating the camshafts 28 and 30 in response to drive signals provided by the computer 52. The computer 52 may include a read-only memory 53 storing engine parameters including optimum camshaft angles for opening and closing both the intake valve 20 and the exhaust valve 22 as a function of various engine operating conditions such as crankshaft angle and rate of rotation, as well as possibly intake air mass flow rate and accelerator pedal position, by way of example. Based on a program and on data stored in the memory 53 as well as data provided to the computer 52 by engine sensors, as are well-known, the computer 52 is programmed to output the drive signals to the electric motors for rotating the camshafts 28 and 30, thereby to operate the valves 20 and 22 at the optimum times, respectively, for accomplishing the intake and the exhaust functions. Information stored in the memory 53 of the computer 52, with respect to the optimum timing of each of the valves 20 and 22, may be obtained by experimentation. The functions provided by the computer 52 may be provided by the engine-control computer found in a modern-day engine, which computer may be provided, in accordance with the invention, with programming designed to optimize the timing of the operation of the exhaust valve 22 for best fuel efficiency of the engine.

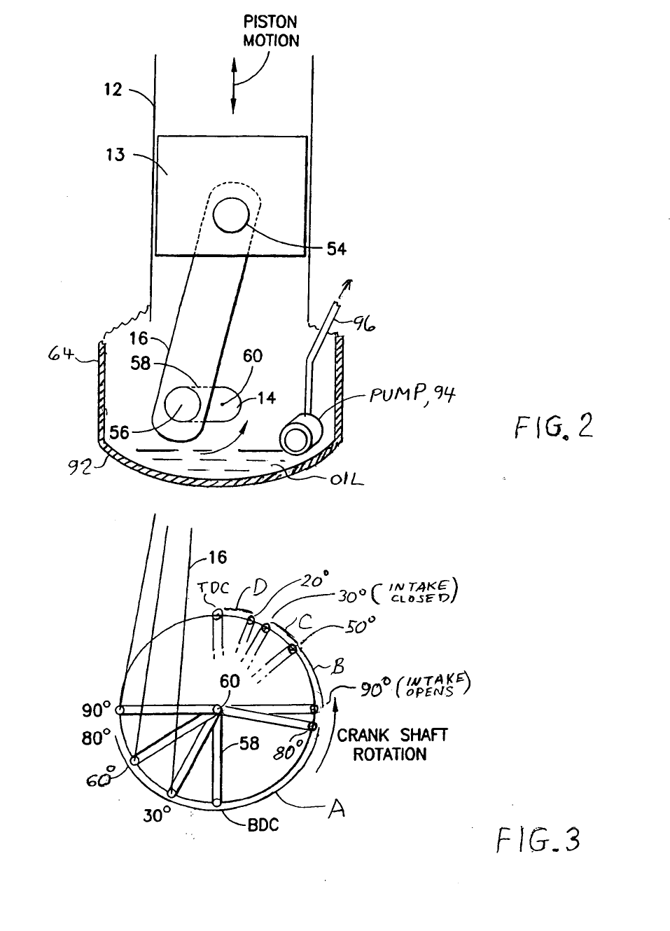

With reference also to FIG. 2, which presents a fragmentary view of the engine 10 taken in a direction parallel to an axis of the crankshaft 14, connection of the piston 13 to the connecting rod 16 is made by way of a pin 54 that enables the connecting rod 16 to pivot relative to the piston 13. The opposite end of the connecting rod 16 connects with the crankshaft 14 via a journal 56 located in a crank arm 58 of the crankshaft 14, the journal 56 permitting the crankshaft 14 to rotate about its axis 60 relative to the connecting rod 16. The crankshaft 14 is supported by a set of bearings 62, two of which are shown in FIG. 1, located in a housing 64 of the engine 10. The bearings 62 enable the crankshaft 14 to rotate relative to the housing 64.

FIG. 1 further shows the feeding of fuel to respective cylinders 12 of the engine 10 via an intake manifold 66 and the removal of products of combustion (exhaust) from the respective cylinders 12 via an exhaust manifold 68. The intake ports 34 of the respective cylinders 12 connect via pipes 70 to the intake manifold 66, and the exhaust ports 36 of the respective cylinders 12 connect via pipes 72 to the exhaust manifold 68. Intake air arrives at an air filter 74 and passes from the filter 74 to the intake manifold 66 via a conduit 76. Connection of the conduit 76 to the intake manifold 66, in the preferred embodiment of the invention, is made via an impeller 78 that forces the air from the filter 74 into the intake manifold 66 under pressure. Typically, the impeller has the form of a fan which is rotated rapidly to drive the air into the intake manifold 66. The impeller 78 may be driven by the output shaft 80 of a turbine 82 of a turbocharger 84 driven by exhaust gasses from the exhaust manifold 68. Alternatively, the impeller 78 may be driven by an electric motor 86 instead of the turbocharger 84.

In the case of operation of the engine 10 as a diesel engine, the air from the intake manifold is fed into the respective cylinders 12, under regulation of the respective intake valves 20 with the fuel being supplied separately by the fuel injectors 42 of the respective cylinders 12. In the case of a modern engine, fuel is provided by a valve controlled by a computer, such as the computer 52, which establishes a suitable rate of fuel flow based on parameters such as engine speed and accelerator position (in the case of an automobile), by way of example. However, in the situation wherein the engine 10 is operating as a gasoline engine, and is burning gasoline or kerosene (or heating oil or diesel fuel), the fuel is applied, in a preferred embodiment of the invention, in liquid form to a fuel injector 88 that injects the fuel as an atomizing spray into the air in the intake manifold 66. It is also possible to provide fuel in gaseous form (such as propane) via the fuel injector 88, in which case the nozzles and valve assembly (not shown) of the fuel injector 88 are adapted for the metering of the gaseous fuel into the air. Thus, the pipes 70 carry a mixture of fuel and air from the intake manifold 66 to the cylinders 12. By way of alternative embodiment, instead of using the fuel injector 88, a carburetor 90 may be connected into the conduit 76 to provide for a mixing of fuel with the intake air to provide a fuel-air mixture in the intake manifold 66 for distribution among the various cylinders 12.

The foregoing description of the engine 10 in FIG. 1 applies to both a multiple cylinder engine as well as to a single cylinder engine. For the single cylinder engine, one simply closes off the unused ports of the intake manifold 66 and the exhaust manifold 68, thus effectively changing the manifolds to conduits, and wherein the intake manifold (or conduit) is configured for operation with the fuel injector 88, and the exhaust manifold 68 is configured for operation with the turbocharger 84.

With reference again to FIG. 2, the engine housing 64, partially shown in sectional view, includes a crankcase with oil sump 92 partially enclosing the crankcase 14. As has been noted above, in view of the feature of the invention employing valves in the cylinder head 18 (FIG. 1) instead of ports in the sidewall of the a cylinder 12, lubricating oil can be placed in the sump 92 without fear of its spilling out of an intake port or an exhaust port, which ports are found in two-stroke engines of the prior art. In the case of a burning of kerosene in the engine 10, one does not need to place lubricating oil in the sump 92 because kerosene is self-lubricating. However, gasoline does not have the lubricity of kerosene and, therefore, when burning gasoline in the engine 10 it is necessary to add lubricant. In the prior art operation of a two-stroke engine, the lubricant was added directly to the fuel. However, in the engine 10 which embodies the present invention, lubricant in the form of engine oil is advantageously placed in the sump 92, and a pump 94 delivers the oil from the sump 92 via a conduit 96 to moving parts of the engine, such as the valve assembly with it valves and cams, to keep these engine parts lubricated during operation of the engine. By keeping the lubricating oil separate from the fuel, a much cleaner burning of the fuel is obtained with a great reduction in pollutants associated with the combustion process.

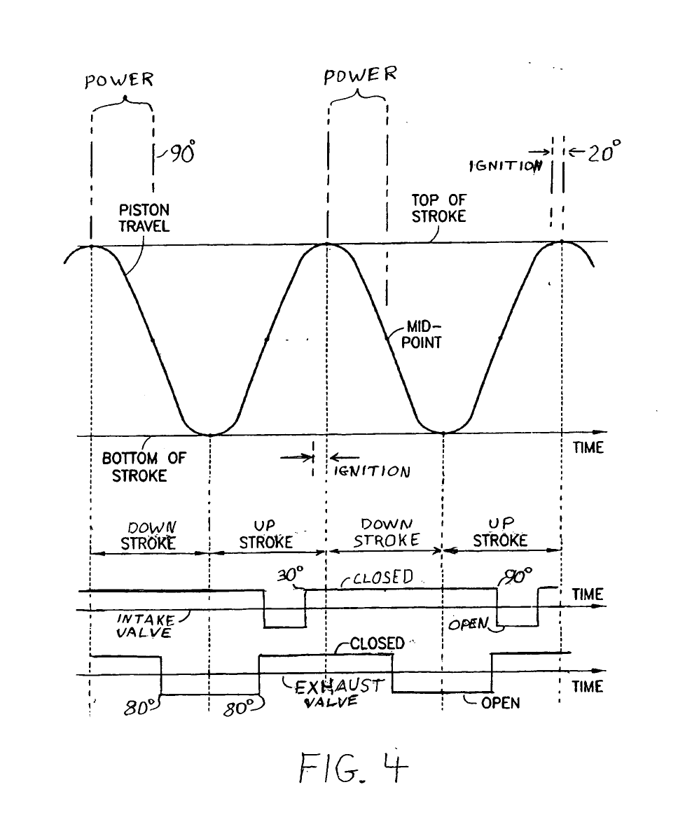

In FIG. 3, the schematic representation of the connecting rod 16 and the crank arm 58 corresponds to the presentation of FIG. 2, and shows various positions of the crank arm 58 assumed during a latter stage of the downstroke, prior to the reaching of bottom dead center, and after bottom dead center during the initial stage of the upstroke, wherein the latter stage of the down stroke and the initial stage of the succeeding upstroke serve as an interval of time for exhausting products of combustion obtained during a burning of fuel at top dead center and during the initial stage of the downstroke. Also shown in FIG. 3 are the positions of the crankshaft corresponding to the events of opening the intake valve, closing the intake valve, and ignition of the fuel-air mixture.

FIG. 4 presents a timing diagram showing the various strokes of the piston travel with the reciprocating motion in the cylinder. Also shown are the open and closed positions of the intake and the exhaust valves with reference to the piston travel, the positions of the valves being presented as separate graphs of the timing diagram in registration with a graph of the piston travel. Each graph has a horizontal axis representing the time. In the first graph at the top of the diagram, the piston travel is shown as a sinusoidal movement between the top of the stroke and the bottom of the stroke, identified in the figure. The midpoint of a stroke is also identified. Two full cycles of the two-stroke operation are shown, with the down-stroke and the up-stroke of each of the cycles being identified. Also identified are the power phase (or time interval) of a down-stroke, extending from TDC to 90 degrees after TDC, and an ignition phase (or time interval), extending from 20 degrees before TDC to TDC, during which phases of the operation both of the intake and the exhaust valves are closed.

With reference to both FIGS. 3 and 4, the operation is explained for an individual cylinder of a multiple cylinder-stroke engine, which operation applies also to the sole cylinder of a single-cylinder two-stroke engine. The exhaust valve opens once during a single cycle of the crankshaft rotation, and closes once during the single cycle of the crankshaft rotation. Movement of either one of the valves between a fully opened position and a fully closed position is considered to take approximately 10 degrees of crankshaft rotation, the amount of crankshaft rotation depending on the design of a specific engine. However, for an understanding of the operation of the engine, it suffices to assume the ten-degree interval of crankshaft rotation. Opening of the exhaust valve begins at 90 degrees after TDC, the exhaust valve remains open during an interval of crankshaft rotation, identified by the letter “A” in FIG. 3, and the opening is completed at 80 degrees after BDC in a preferred embodiment of the invention. It is understood that these values of crankshaft angle may vary somewhat from engine to engine. Closure of the exhaust valve begins at 80 degrees after BDC, and the exhaust valve is regarded as being fully closed when the crankshaft reaches 90 degrees after BDC.

By way of alternative embodiments of the invention, one can operate the two-stroke engine with a closure of the exhaust valve before the piston reaches BDC, and then both of the exhaust and the intake valves would remain closed until the opening of the intake valve during the upstroke. Further discussion of the operation of the exhaust valve appears below with reference to the Robinson U.S. Pat. No. 7,040,264. Also, further embodiments of the invention are directed to the operation of the intake valve in the ensuing description, which deals first with the operation of the intake valve in the preferred embodiment of the invention, followed by the alternative embodiment.

In the preferred embodiment, opening of the intake valve begins at 90 degrees after BDC, the intake valve remains open during an interval of crankshaft rotation, identified by the letter “B” in FIG. 3, and the opening is completed at 50 degrees before TDC in the preferred embodiment of the invention. Closure of the intake valve begins at 50 degrees after BDC, and the exhaust valve is regarded as being fully closed when the crankshaft reaches 30 degrees before TDC. The twenty-degrees closure interval, identified by the letter “C” in FIG. 3, is provided for the intake valve to be sure that the valve is securely closed to withstand a relatively small amount of compression of intake gasses that develops as the piston continues to move towards TDC. Another 10 degrees of crankshaft rotation is provided before inception of the spark-plug ignition interval, identified by the letter “D” in FIG. 3. The spark-plug ignition interval extends from 20 degrees before TDC to TDC (as was previously described with respect to FIG. 3). Following TDC, the piston begins the power phase of a down-stroke, extending from TDC to 90 degrees after TDC (as was previously described with respect to FIG. 3).

By way of further alternative embodiments of the invention, one can operate the two-stroke engine with an opening of the intake valve during the downstroke, provided that the opening of the intake valve takes place after the exhaust valve has closed.

In the preferred embodiment of the invention, it is significant that the intake valve is securely closed at the aforementioned value of 30 degrees before TDC because this allows relatively little further upward motion of the piston before reaching TDC. Consequently, there is only a relatively small amount of compression of the fuel-air mixture during the terminal phase of the upstroke. This can be appreciated upon comparison of the engine 10 with other two-stroke engines of the prior art. For example, in the case of a diesel two-stroke engine, it is the practice to complete the exhaust phase of the engine cycle in the terminal portion of the down-stroke, followed by an opening of an intake port at the beginning of the upstroke, followed by a closing of the intake port while the piston is still in the initial portion of the upstroke. This produces a compression ratio of intake air during the upstroke which is approximately equal to the expansion ratio of the down stroke (approximately 15:1). As a further example, in the case of a gasoline two-stroke engine, it is the practice to complete the exhaust phase of the engine cycle in the initial portion of the up-stroke, followed by an opening of an intake port in the middle portion of the upstroke, followed by a closing of the intake port while the piston is still in the middle portion of the upstroke. This produces a compression ratio of intake air during the upstroke which is approximately equal to the expansion ratio of the down stroke (approximately 8:1).

As was explained above with reference to the Robinson patents, engine efficiency can be improved by reducing the magnitude of the compression ratio of air (in the case of a diesel engine) or of a mixture of air and fuel (in the case of a gasoline engine) occurring in the engine stroke preceding ignition relative to the expansion ratio of the burning engine gasses occurring in the power stroke following the ignition. This beneficial result of improved efficiency is obtained in the practice of the present invention with the engine 10 by withholding compression during the upstroke until the terminal phase of the upstroke, which terminal phase begins at 30 degrees before TDC in the preferred embodiment of the invention. The relatively late closing of the intake valve greatly reduces the compression ratio without changing the magnitude of expansion ratio of the downstroke, thereby accomplishing the improved efficiency addressed by the foregoing Robinson patents.

With reference again to the practice of the prior art operation of the diesel two-stroke engine, wherein there is completion of the exhaust phase of the engine cycle in the terminal portion of the down-stroke, an improvement in the efficiency of the engine can be obtained by avoidance of the relatively late opening of the exhaust valve in the terminal portion of the down-stroke, and by advancing the time of the opening of the exhaust valve as has been explained in the aforementioned Robinson U.S. Pat. No. 7,040,264. While the teachings of Robinson U.S. Pat. No. 7,040,264 are presented with respect to a four-stroke engine, it is recognized that the teachings of Robinson U.S. Pat. No. 7,040,264 apply also in an operation of the present two-stroke engine as a diesel with intake of air only (not a fuel-air mixture) in the terminal phase of the upstroke, such that advancement of the opening of the exhaust valve during the downstroke occurs in a range of 40-80 degrees of crankshaft rotation prior to bottom dead center.

A further feature of the present invention is obtained by operating the engine 10 in a fashion which permits use of any one of the aforementioned variety of fuels (high octane gasoline, low octane gasoline, diesel fuel, heating oil, kerosene, or a gaseous fuel such as propane). This feature is obtained by limiting a rise in temperature of the fuel-air mixture in the terminal phase of the upstroke, in the interval of time from the closure of the intake valve to activation of the spark plug, so as to prevent preignition. This rise in temperature is associated with compression of the fuel-air mixture by the upwardly moving piston. No such compression takes place while the intake valve is open providing communication between the internal space of the cylinder and the intake manifold, since some of the air-fuel mixture is free to move out of the cylinder into the intake manifold as the piston moves toward the cylinder head. Thus the pressure in the cylinder is substantially equal to the pressure in the intake manifold until the intake valve closes. Thereafter, the pressure and the temperature both rise. However, since the compression is relatively small during this terminal phase of the upstroke, the rise in temperature also is relatively small, thereby to avoid preignition of the fuel-air mixture.

It is of interest to consider actual values of compression ratios of the fuel-air mixture that may be obtained in the terminal phase of the upstroke as a function of the closing time of the intake valve (in terms of crankshaft angle) and as a function of the piston configuration (which give the expansion ratio obtained in the downstroke). In the aforementioned discussion of the common four-stroke gasoline engine, an example was given of a piston having a stroke of 7 cm (in which case the crankshaft arm is 3.5 cm) with a space of one centimeter between the top surface of the piston head and the cylinder head at TDC. This geometry provided a compression ratio of 8:1 with an expansion ratio of the same magnitude (8:1). By altering the piston head to provide a taller head, taller by 0.5 cm, the compression and expansion ratios were both changed to 15:1.

One may use the same dimensions for piston, stroke and cylinder for discussion of the present two-stroke engine 10. One may estimate the location of the top surface of the piston head by considering the contribution of the crankshaft arm (angled at 30 degrees) and by considering the contribution of the crankshaft arm (which may be three to four times as long as the crankshaft arm, and may be regarded as pivoting from the piston surface at a smaller angle, approximately 15 degrees). For both contributions, simple arithmetic gives their projections along the cylinder axis, thereby to locate the top surface of the piston head at the 30 degree closing point of the intake valve. Upon comparing the volume of the combustion chamber at the closing point of the intake valve to the volume of the combustion chamber at TDC, one obtains the compression ratio resulting from the piston movement during the terminal phase of the upstroke.

The following values were calculated for a terminal phase of the upstroke beginning at 30 degrees BTDC and also beginning at 35 degrees BTDC. For a regular piston providing an expansion ratio of 8:1, the terminal phase compression ratio is 1.9 and 2.3 respectively for 30 degree and 35 degree terminal phases. For a taller piston providing an expansion ratio of 15:1, the terminal phase compression ratio is 2.8 and 3.4 respectively for 30 degree and 35 degree terminal phases. For the tallest piston providing an expansion ratio of 20:1, the terminal phase compression ratio is 3.4 and 4.2 respectively for 30 degree and 35 degree terminal phases.

The calculated values show that the value of 30 degrees intake closure employed in the preferred embodiment of the invention is optimal for a two-stroke engine intended to power a motor vehicle, and to use kerosene as the fuel. For example, if the engine were to employ the tallest piston (20:1 expansion ratio) then the 35 degrees intake closure would result in a 4.2 compression ratio which is a border line value with respect to preignition of kerosene. Hence, it would be safer to use the 30 degrees intake closure. If the regular height or the taller piston, only, were to be employed then it appears that the 35 degrees intake closure could be safely employed without danger of preignition. The actual range of values available for the closure of the intake valve should be determined by experiment. Thus, it is clear that delaying the closure of the intake valve (from 35 degrees to 30 degrees and possibly to values closer to TDC) increases the variety of fuels available for running the engine.

On the other hand, if a driver anticipates that it will be desirable to have more power during certain aspects of the driving, such as occasional pulling of trailer by way of example, and the driver is willing to use an octane gasoline, then the closure of the intake valve may be advanced to 60 degrees before TDC for a piston of regular height providing an 8:1 expansion ratio. Assuming the intake valve is opening at 90 degrees before TDC, this provides an interval from 30 degrees of crankshaft rotation to fill the cylinder with the fuel-air mixture. The compression ratio is below 4.0 to permit even the kerosene.

With respect to the possibility of a closure of the intake valve closer to TDC than the foregoing value 30 degrees, it is noted that the ignition phase is set (FIG. 4) in the range of crankshaft angles between TDC and 20 degrees BTDC. This range has a long history of successful operation of motor vehicles for highway driving wherein the range of crankshaft rotation rate, 1000-3000 revolutions per minute (RPM), is well adapted to a spark advance interval between TDC and 20 degrees BTDC. Thus, there is little opportunity for further delaying of the closure of the intake valve in an engine intended for automotive operation. However, if the engine is intended for another purpose, such as the running of a generator of electricity, by way of example, wherein the engine is to run at a constant speed, the speed may be selected for a relatively slow speed of 1000 RPM. In such a situation, the spark advance can be reduced to a value much closer to TDC and, in corresponding fashion, the closure of the intake valve, and the initiation of the terminal phase of the upstroke, may be delayed until possibly 20 degrees BTDC for crankshaft rotation rates below approximately 1500 RPM. This would reduce the compression associated with the terminal phase of the upstroke for improved efficiency while avoiding any chance of preignition with fuels such as heating oil and kerosene. It is noted that heating oil and kerosene are regularly stored and used safely in persons' homes, so that it would be advantageous to have an engine that can run on these fuels.

Thus, by the simple expediency of variable valve adjustment applied to the intake valve, the invention provides for selection of upstroke terminal phase compression to suit the task for which the two-stroke engine 10 is to be assigned while maximizing the available range of fuels, and while improving engine efficiency, in accordance with the task to be performed by the engine. The computer 52 in the timing device 44 (FIG. 1) may store, in its memory, values of compression (such as those calculated above) as a function of various operating parameters, such as the closure time of the intake valve and ignition temperature of fuel vapors, to set the closure time of the intake valve to a value that is optimum for a specific task, and to warn a user of the engine in a home environment as to the safety of a specific fuel.

Another aspect in the use of the variable valve timing pertains to the use of the two-stroke engine 10 for powering a motor vehicle. The closing time of the intake valve can be delayed during the upstroke (made closer to TDC) to increase the engine efficiency during intervals of low power output of the engine, such as during a drive along a highway on level land when the accelerator pedal is only slightly depressed. Under such driving condition, the vehicle transmission is probably is overdrive so that engine crankshaft is revolving at a relatively slow rate of revolution, and the activation of the spark plug is delayed (the spark advance is reduced) for activation of the spark plug closer to TDC. Thus there is an opportunity to delay the closing of the intake valve for improved efficiency. On the other hand, if the road begins to go up hill, the driver presses down on the accelerator pedal, the transmission may down-shift to a lower gear and the crankshaft rate of revolution increases. The spark-plug activation is advanced and also the closing time of the intake valve may be advanced with a resultant increase in the upstroke terminal phase compression. The engine consumes considerably more fuel to output more power, but at reduced efficiency. However, later when the road proceeds to level off or to go down hill, the opportunity for retarding the closure of the intake valve returns so that the engine can be operated in a more efficient manner. This automatic selection of closure time for the intake valve can be accomplished by the computer 52 (FIG. 1) based on data of vehicular parameters, such as crankshaft rotation data received on line 50, and further data received from sensors 98 such as a transmission gear sensor 100 and an accelerator position sensor 102.

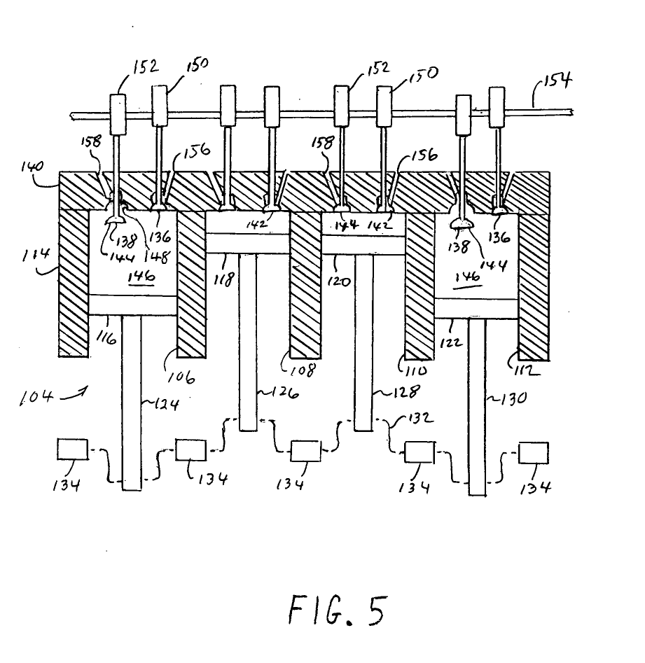

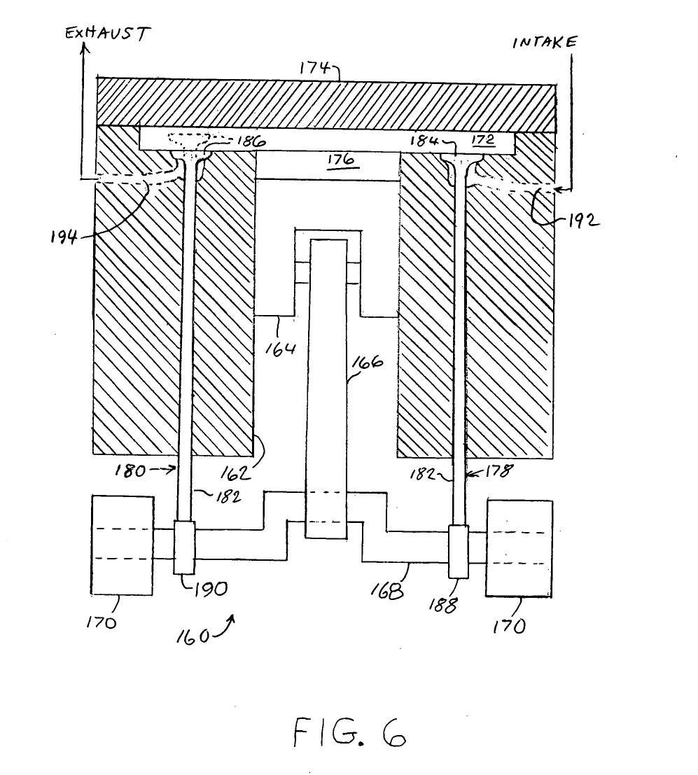

FIG. 5 shows an engine 104 which is an alternative embodiment of the engine 10 of FIG. 1. In FIG. 5, the engine 104 is a two-stroke engine having four cylinders 106, 108, 110 and 112 arranged in line, constructed in a common cylinder block 114. The engine 104 has four pistons 116, 118, 120 and 122 located in their respective cylinders 106, 108, 110 and 112 and connecting via connecting rods 124, 126, 128 and 130 to a common crankshaft 132. The crankshaft 132 is supported for rotation in bearings 134. Each of the cylinders has an intake valve 136 and an exhaust valve 138 located in a head 140 of the cylinder block 114. The spark plugs of the respective cylinders are omitted to simplify the drawing. Heads 142 of the respective intake valves 136 and heads 144 of the respective exhaust valves 138 open by downward motion into a combustion chamber 146, and are raised upwards against the respective valve seats 148 for closure of the respective valves. The intake valves 136 are driven by respective cams 150, and the exhaust valves 138 are driven by respective cams 152, all of the cams 150 and 152 being on a common camshaft 154. Intake channels 156 in the cylinder head 140 connect with the respective intake valves 136 for bringing in air or a fuel-air mix to the combustion chambers 146, and exhaust channels 158 in the cylinder head 140 connect with the respective exhaust valves 138 for exhausting products of combustion from the combustion chambers 146. In terms of the firing order of the cylinders, ignition occurs simultaneously in the first and the fourth cylinders 106, 112. Ignition occurs simultaneously in the second and the third cylinders 108, 110, and occurs 180 crankshaft degrees apart from the ignition of the first and the fourth cylinders 106, 112. By way of portrayal of the cylinders, the pistons 116 and 112 of the cylinders 106 and 112 are shown at bottom dead center at the conclusion of their respective downstrokes with open exhaust valves 138 and closed intake valves 136, while the pistons 118 and 120 of the cylinders 108 and 110 are shown at the top dead center at the conclusion of their respective upstrokes wherein both of the intake and exhaust valves are closed.

FIG. 6 shows part of a two-stroke engine 160 which differs from the engine 10 of FIG. 1 in respect to the construction of a cylinder 162 of the of the engine 160. The cylinder 162 has a piston 164 which translates therein, and is connected by a connecting rod 166 to a crankshaft 168. The crankshaft 168 is supported for rotation by bearings 170. The cylinder 162 has a uniform diameter throughout its length, except for its top portion which is constructed as a reentrant cavity 172 with the configuration of a shelf extending laterally into the sidewall of the cylinder 162. The cylinder 162 is closed off on its top by a cylinder head 174 to define a combustion chamber 176 between the cylinder head 174 and the top of the piston 164, the combustion chamber 176 including the reentrant cavity 172 and being bounded laterally by the cylindrical sidewall. An intake valve 178 and an exhaust valve 180 are provided with elongated stems 182 extending parallel to an axis of the cylinder 162 from respective valve heads 184, 186 at the reentrant cavity 172 to respective cams 188, 190 located directly on the crankshaft 168. The valves 178 and 180 move up and down in response to rotations of the cams 118 and 190, wherein a closure of a valve is obtained when its head rests on the valve seat, and wherein an opening of a valve is obtained when its head protrudes upwardly into the reentrant cavity 172. The valves are shown in the closed position, and the exhaust valve 180 is shown also, by phantom view, in the open position. An intake channel 192 brings intake air or fuel-air mixture to the intake valve 178, and an exhaust channel 194 serves to carry off combusted gasses that have exited the combustion chamber 176 via the exhaust valve 180.

It is to be understood that the above described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. An internal combustion engine comprising:
a cylinder with a cylinder head closing off an end of the cylinder;
a crankshaft and a piston connecting with the crankshaft, the piston being mounted for reciprocating movement within the cylinder wherein the piston is movable via an upstroke in a direction toward the head and via a downstroke in a direction away from the head, and wherein a single cycle of the crankshaft is accomplished with a piston downstroke and a following piston upstroke, a region within the cylinder being established as a combustion chamber defined by a space between the piston and the cylinder head;
a valve assembly including an intake valve and an exhaust valve providing for communication of gasses between the combustion chamber and locations outside of the combustion chamber, and a timing device for synchronizing the valve assembly to rotations of the crankshaft, the valve assembly providing for the opening and the closing of the intake valve and the exhaust valve for a two-stroke operation of the engine;
wherein, in said operation of the engine, the valve assembly provides for a closure of both of said valves during a terminal stage of said upstroke to establish an interval for ignition of gasses in the combustion chamber;
the valve assembly provides for a closure of both of said valves during an initial stage of said downstroke to establish a power interval for imparting rotation to the crankshaft;
the valve assembly provides for an opening of said exhaust valve during a terminal stage of said downstroke to establish an exhaust interval for exhausting products of combustion from the combustion chamber;
the valve assembly provides for the closure of said exhaust valve at the end of the exhaust interval and an opening of said intake valve after the closure of the exhaust valve, the opening of the intake valve occurring prior to the terminal stage of said upstroke to establish an intake interval for conduction of fuel and air into the combustion chamber; and
the intake interval terminates with a closing of the intake valve prior to an ignition of the gasses in the combustion chamber.

2. An engine according to claim 1, wherein said cylinder is a first cylinder, said engine further comprising a plurality of cylinders including said first cylinder, said plurality of valves includes an intake valve and an exhaust valve for each of said plurality of cylinders, and said engine further comprises a driver of the fuel, an impeller of air and an intake manifold, said intake manifold interconnecting said driver and impeller with the intake valves of respective ones of said cylinders, said driver providing an ingress of fuel and said impeller providing an ingress of air into the intake manifold.

3. An engine according to claim 1, further comprising a driver of the fuel and an impeller of air via said intake valve into the combustion chamber upon an opening of said intake valve during said upstroke.

4. An engine according to claim 2, wherein the fuel is in vapor form during the ingress of the fuel into the combustion chamber from the intake manifold.

5. An engine according to claim 4, wherein the fuel vapor is mixed with intake air inside the intake manifold, and said impeller drives a mixture of the fuel and the intake air.

6. An engine according to claim 5, wherein the valve assembly includes a camshaft, and wherein the air impeller is drivable by an electric motor or by a mechanical power link from the crankshaft or from the camshaft.

7. An engine according to claim 5, wherein the impeller comprises a turbocharger driven by engine exhaust gasses.

8. An engine according to claim 1, further comprising a spark plug, operable during said ignition interval in the terminal stage of said upstroke for igniting gasses within the combustion chamber.

9. An engine according to claim 8, wherein the timing device operates the valve assembly and the spark plug in synchronism with rotations of the crankshaft to provide for an ignition of fuel-air mixture once during each cycle of the crankshaft.

10. An engine according to claim 1, wherein the crankshaft is mounted within main bearings of the engine, and wherein portions of the crankshaft adjacent to the main bearings are formed with cam surfaces to provide a series of cams for driving respective ones of said valves.

11. An engine according to claim 1, further comprising a crankcase for holding lubricant below the crankshaft, and a pump for directing the lubricant to the valve assembly.

12. An engine according to claim 11, wherein the exhaust and intake valves open into the combustion chamber of the cylinder above the location of the piston at top dead center.

13. An engine according to claim 1, wherein closure of the intake valve occurs in the upstroke during an interval of crankshaft rotation from 60 degrees to 30 degrees before top dead center to reduce a compression ratio from the upward movement of the piston with a reduced increase of the temperature of the gasses in the combustion chamber resulting from compression by the piston to enable burning of any one of a range of fuels including gasoline, diesel fuel, kerosene, and heating oil.

14. An engine according to claim 13, wherein closure of the intake valve occurs in the upstroke during an interval of crankshaft rotation from 50 degrees to 30 degrees before top dead center.

15. An engine according to claim 1, wherein closure of the intake valve occurs in the upstroke during an interval of crankshaft rotation from 60 degrees to 20 degrees before top dead center to reduce a compression ratio from the upward movement of the piston with a reduced increase of the temperature of the gasses in the combustion chamber resulting from compression by the piston to enable burning of any one of a range of fuels including gasoline, diesel fuel, kerosene, and heating oil, and wherein the closure of the intake valve is regulated in accordance with crankshaft rotation rate to provide the value of 20 degree for the closure of the intake valve at a crankshaft rotation rate below 1500 RPM.

16. An engine according to claim 1, wherein the valve assembly is capable of advancing and retarding a closing time of the intake valve in accordance with parameters of a vehicle driven by the engine for increasing alternatively efficiency or power output of the engine in response to driving conditions of the vehicle.

17. An internal combustion engine comprising:
a cylinder with a cylinder head closing off an end of the cylinder;
a crankshaft and a piston connecting with the crankshaft, the piston being mounted for reciprocating movement within the cylinder wherein the piston is movable via an upstroke in a direction toward the head and via a downstroke in a direction away from the head, and wherein a single cycle of the crankshaft is accomplished with a piston downstroke and a following piston upstroke, a region within the cylinder being established as a combustion chamber defined by a space between the piston and the cylinder head;
a valve assembly including an intake valve and an exhaust valve providing for communication of gasses between the combustion chamber and locations outside of the combustion chamber, and a timing device for synchronizing the valve assembly to rotations of the crankshaft, the valve assembly providing for the opening and the closing of the intake valve and the exhaust valve for a two-stroke operation of the engine;
wherein, in said operation of the engine, the valve assembly provides for a closure of both of said valves during a terminal stage of said upstroke to establish an interval for ignition of gasses in the combustion chamber;
the valve assembly provides for a closure of both of said valves during an initial stage of said downstroke to establish a power interval for imparting rotation to the crankshaft;
the valve assembly provides for an opening of said exhaust valve during a terminal stage of said downstroke to establish an exhaust interval for exhausting products of combustion from the combustion chamber;
the valve assembly provides for the closure of said exhaust valve at the end of the exhaust interval and an opening of said intake valve after the closure of the exhaust valve, the opening of the intake valve occurring prior to the terminal stage of said upstroke to establish an intake interval for conduction of fuel into the combustion chamber; and
the intake interval terminates with a closing of the intake valve prior to an ignition of the gasses in the combustion chamber; and
wherein the timing device is capable of delaying initiation of said ignition and closure of said intake valve at a relatively low rate of said crankshaft rotation for increased efficiency with reduced power of said engine while enabling increased power with reduced efficiency of said engine at a relatively high rate of said crankshaft rotation.

18. An engine according to claim 17 wherein said timing device includes a computer with memory for storing engine parameters including optimum camshaft angles relative to crankshaft rotation for opening and closing both the intake valve and the exhaust valve as a function of various engine operating conditions.
